(19) United States
(12) Patent Application Publication
(10) Pub. No.: US 2017/0046139 A1
(43) Pub. Date: Feb. 16, 2017

(54) Parsing and Interpretation of Logical Statements

(71) Applicant: XIAOHUA YI, Superior, CO (US)

(72) Inventor: XIAOHUA YI, Superior, CO (US)

(21) Appl. No.: 14/827,106

(22) Filed: Aug. 14, 2015

(51) Int. Cl. G06F 9/45; G06F 17/27; G06N 5/00

(52) U.S. Cl. CPC G06F 8/427; G06N 5/006; G06F 17/271; G06F 17/274

(57) ABSTRACT

Methods, systems, and devices are described that enable parsing and interpretation of logical statements in “native style” with syntax that is very similar to that of first-order-logic (FOL) and “prose style” with which logical statements are expressed in English prose, or a mixture of both English prose and FOL.

### BACKGROUND

Reasoning is an essential part of mathematical educations. The theoretical foundation such as first-order-logic (FOL) and algorithms for reasoning are well established. However, reasoning functionality is largely missing from major math software available in the market, which unfortunately is also what commonly available for educational applications.

The grammar of FOL may include many constructs including predicate, FOL function, term, and quantifiers. Its expressive power makes it a common choice of representation of mathematics axioms/theorems, as well as “meaning” in natural language processing, although it may not be always straightforward in translating English sentences into a corresponding FOL representation.

Traditional math software or computer languages are generally not able to parse and interpret (including reason) logical statements such as logical puzzles or mathematical theorems in FOL syntax directly. Being able to communicate with software in native FOL syntax is desirable at least for educational users such as STEM students who are learning formal reasoning, since it largely eliminates the needs to learn a new language.

There are several programming languages that are directed to logical reasoning. Many of these languages suffer several limitations including:
1. only allowing a subset of FOL sentences called Horn clauses (disjunction of one or more boolean literals with at most one positive literal);
2. assuming variables to be universally quantified. Such restriction makes it hard for using it in mathematical reasoning, where existentially quantified variables are indispensable in defining many mathematics concepts and theorems, such as limit and the intermediate-value-theorem in single-variable calculus;
3. reasoning algorithms based on backward-chaining. Other common methods such as forward-chaining (which is perhaps the most intuitive to human reasoners) and resolution refutation (a versatile procedure that only require sentences written in clause forms, i.e. disjunction of Boolean literals), may not be available.

While the above restrictions may provide enhanced efficiency of such languages, the deficiency in logical expressiveness is adversely impacted. Furthermore, there exist some noticeable syntactic difference between many such languages and FOL. For example, implication may be expressed in some languages in a reversed manner with the “:−” operator being used for the universally accepted symbol “=>” and comma ‘,’ for conjunction ‘ [symbol] ’ (i.e., the FOL sentence p [symbol] q=>r in such a case would be expressed as r :− p, q in Prolog). While such languages may well be a powerful language for language processing and expert systems, it is possibly not a good choice for teaching and learning logical reasoning.

The languages used by major math software are mostly functional languages and lack the features that enable the definition of logical statements, let alone the ability to reason.

Various aspects of the present disclosure enable parsing and subsequently interpreting logical statements that are written in syntax similar to that of FOL or in English prose, or both.

### SUMMARY

The present disclosure generally relates to one or more improved systems, methods, and/or apparatuses for parsing and interpretation of logical statements. Aspects disclosed herein provide entering logical statements into computer (software) in native FOL syntax using ASCII and providing solutions to reasoning problems presented in the logical statements, the solutions determined based on math theorems (specifically theorems in single-variable calculus) in FOL that are used to solve the math reasoning problems, and linking different theorems to the FOL statements.

### BRIEF DESCRIPTION OF THE DRAWINGS

FIG. 1 illustrates an abstract syntax tree (AST) in accordance with examples of the present disclosure;

FIGS. 2A and 2B illustrate an example of definite clauses of an example of the present disclosure;

FIGS. 3A and 3B illustrate an example of a contradiction and the reasoning problem in accordance with aspects of the present disclosure;

FIGS. 4A through 4C illustrate an example of a resolution refutation problem in accordance with aspects of the present disclosure;

FIG. 5 illustrates an example of a comparison of ASTs in accordance with aspects of the present disclosure;

FIGS. 6A through 6C illustrate an example of a problem and solution in accordance with aspects of the present disclosure;

FIGS. 7A through 7C illustrate another example of a problem and solution in accordance with aspects of the present disclosure;

FIGS. 8A through 8B illustrate an example of a problem and solution in accordance with aspects of the present disclosure;

FIG. 9 illustrates an example of another AST in accordance with aspects of the present disclosure;

FIGS. 10A through 10B illustrate another example of a problem and solution in accordance with aspects of the present disclosure;

FIG. 11 is a screenshot of an example of an interpreter according to some examples of the present disclosure;

FIGS. 12A through 12C illustrate another example of a problem and solution in accordance with aspects of the present disclosure;

FIG. 13 is a screenshot of an example of an interpreter and flow diagram according to some examples of the present disclosure;

FIG. 14 is an illustration of the mean-value-theorem that can lead the reasoning engine into an infinite loop according to some examples of the present disclosure;

FIG. 15 is a block diagram of an exemplary system according to some examples of the present disclosure; and

FIG. 16 is a block diagram of an exemplary computing network according to some examples of the present disclosure.

### DETAILED DESCRIPTION

As mentioned above, various aspects of the present disclosure enable parsing and subsequently interpreting logical statements that are written in syntax similar to that of FOL or in English prose, or both. This is achieved by expanding Leibniz language—a hybrid language that mixes simple English with mathematical expressions that is described in more detail in U.S. Pat. No. 8,943,113, which is incorporated herein by reference in its entirety.

In this section, various aspects of FOL grammar are discussed, followed by how FOL constructs are represented and how the FOL grammar is merged according to various aspects of the disclosure. Finally a few examples of reasoning problems, both English words problems and math reasoning problems in single-variable calculus, that are parsed and interpreted (i.e. solved) according to aspects of the disclosure are discussed.

### FOL Grammar

To facilitate the discussion, first discussed are grammar rules for FOL and the propositional logic (PL). The production rules are defined in Backus-Nour form, which is a standard format commonly used when defining the syntax of a computer language:

```
<sentence> -> <atomic sentence> |
      <sentence> <connective> <sentence> |
      <quantifier> <variable list> <sentence> |
      ~<sentence>
<atomic sentence> -> <predicate> | <term> = <term>
<connective> -> => | [symbol]   | [symbol]   | <=>
<quantifier> -> ∀ | ∃
<predicate> -> <predicate head> ‘(‘ <term list> ‘)‘
<term> -> <function> | <constant> | <variable>
<function> -> <function head>‘(‘ <term list> ‘)‘
<variable> -> x|y|u|T...
<constant> -> C|Ann|limon bar|tea| ...
<predicate head> -> love|hate|alive|...
<function head> -> tax|mother|age|...
<term list> -> <term> <term tail>
<term tail> -> ‘,‘ <term> | λ
```

As can be seen, the grammar is context-free since all grammar symbols appeared in the left-hand sides of the rules are single non-terminal symbols (symbols written as < . . . >). Simply, non-terminal symbols are place-holders or abstract notions that are meant to be replaced by terminal symbols (those can not be replaced any further like “2”, “x”, “slope”), or other non-terminal symbols. λ in the last rule is a special terminal symbol that literally means void or nothing; It is needed in terminating recursive structures such as list (e.g., (“John”, “Dave”, x, u, . . . )).

PL is simpler than FOL and it can be treated as a subset of FOL. There are no functions and predicates, and there are no quantifiers. Below are the grammar rules that define the simple logic:

```
<sentence> -> <atomic sentence> |
      <sentence> <connective> <sentence> |
      ~<sentence>
<atomic sentence> -> true|false|<boolean variable>
<connective> -> => | [symbol]   | [symbol]   | <=>
<boolean variable> -> p|q|u|...
```

To incorporate FOL into a computer language, one has to consolidate the FOL grammar and the grammar rules representing arithmatics and math entities such as set, function and matrix. These entities provide the content for logical framework to reason.

### Representation of the FOL Grammar

Such consolidation is described for various aspects of the disclosure, including specifically (i) how the FOL grammar is merged into the existing grammar defining the language; (ii) how the FOL constructs such as predicate and FOL function are represented; and (iii) how quantifications and quantified statements are delimited in a manner that is faithful to the native FOL syntax yet with improved readability.

### Representations of FOL Predicates and FOL Functions

FOL predicates are used to describe relation among objects within the domain the predicates are used to model. For instance, some examples may use predicate

### Son(“John”, “David”)

to represent the son-father relationship “John is David's son”. A predicate can be considered as a function with domain being the set of objects concerned and the range being simply the Boolean value “true.”

On the other hand, FOL functions represent objects (cars, humans, etc)—objects that can be uniquely determined by another object or objects, again within the domain concerned. For example, one can use

### Father(“John”)

to represent John's father. FOL function, it is to be noted, is associated with a unique mapping, or a one-to-one relation. Functions can be used as the arguments of predicates but not predicates in FOL.

As can be seen, FOL predicate and FOL function share the same syntax “some words” (t₁, t₂, . . . ), where t₁, t₂, . . . are FOL terms as defined by the FOL grammar. One has to state explicitly whether such construct represents a predicate or a function. In addition, there is potential confusion with the syntax of mathematical functions ƒ(x,y, . . . ), where the arguments are usually numbers (real, integer, etc) instead of objects.

To avoid the ambiguity, some aspects of the present disclosure introduce the notion of FOL constructors, whose sole purpose is to generate the corresponding FOL construct with given parameters. Notice the first parameter is always a string naming the FOL construct. The table below lists exemplary syntax and functionalities of these constructors:

| Con- | |
|---|---|
| structor | FOL Expression Generated |
| FOL_P | (“some words”, t₁, t₂, ...) predicate: “some words”( t₁, t₂, ...) |
| FOL_A | (“some words”, t₁, t₂, ...) function: “some words”( t₁, t₂, ...) |
| FOL_C | (“some words”, t₁, t₂, ...) class/set: “some words”( t₁, t₂, ...) |

It should be noted that the expression generated by FOL_C is not a genuine FOL term. Rather, it is introduced into the language for the needs of expressing the set-membership or subset relations more transparently. There are many such relations in mathematics such as (function vs antiderivatives). It's convenient to use FOL_C to generate a symbol representing a collection of entities with certain characteristics. Some examples use a FOL_C operator along with “{”(set membership) and “[”(subset) than predicate for this type of relations since the readability of the statements so constructed is arguably improved when capered to a predicate that capturing the same relation. Such techniques may be used for defining types. For example, the declaration “A is a square matrix” can be represented by

A {FOL_C(“square matrix”)
with the implied unary arity. It can trigger the instantiation for A during semantic checking.

Various examples have also used the convention of using double quotations for strings that represent constants—such as “John” as a person, “Olive Garden” as the Italian restaurant chain, etc. As can be seen, it is not clear at all from the grammar specification that how <constant> and <variable> are to be differentiated but such differentiation is important for knowledge representation and reasoning. For instance, if both John and Mary in the predicate

### FOL_P(“loves”, John, Mary)

are flagged as constants (through statement such as “John, Mary are constant;” where constant is recognized as adjective), the sentence simply means “The person named John loves the person named Mary.” On the other hand, if John is flagged as variable (It seems odd but is entirely reasonable. For instance, software languages recognize strings with the first letter capitalized as variables) and Mary remains a constant, the same sentence will carry drastically different meaning; The sentence now claims “everybody love Mary” since by FOL convention John is universally quantified. It should be noted that FOL itself does not have a mechanism for specifying whether a symbol is a variable or constant. As mentioned, some examples use the double quotation convention as an intuitive solution to this problem. Using this convention, the two statements involving Mary's affection affair would be

### FOL_P(“loves”, “John”, “Mary”), and

### FOL_P(“loves”, John, “Mary”)

As explained John here is assumed universally quantified. If however it is quantified as existential by adding quantification “for some John”, the modified sentence means “there is at least one person, if not more, who loves Mary.”

3.2.2 Delimiting FOL Quantification.

No punctuation is specified as delimiter to separate quantification and the quantified statement followed in the formal specification of FOL grammar. In practice, an empty space may be used as a delimiter, or a different font style such as italic for the quantified statement so the quantification and the statement can be identified clearly. While it is not practical to introduce font style in a grammar specification, using empty space as delimiter may also be undesirable due to, for example, diminished readability.

In some examples, a comma ‘,’ is selected as the delimiter for both universal and existential quantifications (when expressed using “for some . . . ”). For example, the following statement with nested quantifications can be used to define ( [symbol] as the logical collective for definition) the notion of sibling-hood and parenthood:

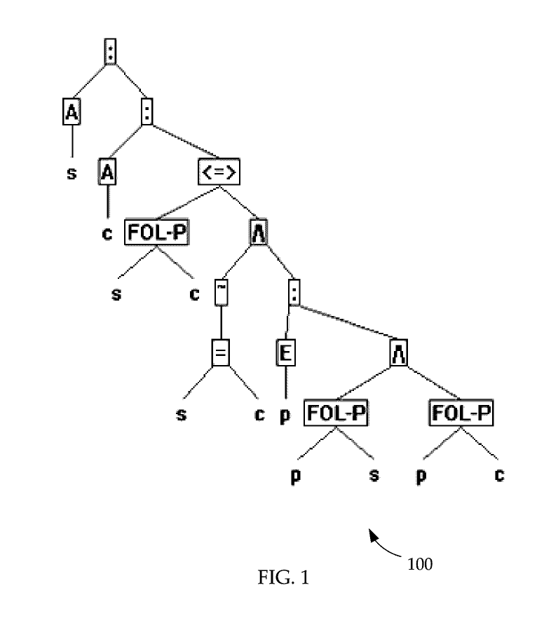

for all s, for all c, FOL_P(“sibling”, s, c)<=>˜(s=c) [symbol] (for some p, FOL_P(“parent”, p, s) [symbol] FOL_P(“parent”, p, c))
The corresponding abstract-syntax-tree (AST) is given in FIG. 1.

Notice that “there exist(s) . . . such that . . . ” phrase structure can also be used to express existentially quantified statements. For example, one may rewrite the existential statement on the right-hand side in the above statement using such a structure, and the statement now reads

for all s, for all c, FOL_P(“sibling”, s, c)<=>˜(s=c) [symbol] (there exists p such that FOL_P(“parent”, p, s) [symbol] FOL_P(“parent”, p, c))
The AST is exactly the same as it should be. In the case that there is only single quantified variable, one may place an indefinite article (a′ or “an”) in front of the quantified variable.

3.2.3 Incorporating FOL Grammar into a Hybrid Language that Mixes Simple English with Mathematical Expressions (e.g., the Leibniz Language).

As mentioned above, various aspects of this disclosure provide enhancements to a hybrid language that mixes natural language and symbolic expressions (e.g., the Leibniz language), and allows declarative definition of assertions, commands, and questions with simple but common syntactic structures found in natural math language. As such, considerable fraction of the existing grammar is devoted to capture the syntactic structures of hybrid sentences and the embedded or stand-alone symbolic expressions, which represent important math concepts/entities such as set, functions and matrices. Understandably, to add FOL grammar into a hybrid language that mixes simple English with mathematical expressions, one has to consolidate it with the existing rules instead of simply injecting them into the language.

Specifically, such consolidation should be such that the math software or computer language can recognize (i) sentences written in native FOL syntax; and (ii) sentences written in simple but well-structured natural math language whose semantics can be captured by FOL. In other words, sentences like

$$\begin{matrix}“ f ( x ) = ( x \hat{} 2 - 4 ) / ( x - 2 ) , if x < 2 \\ = a * x \hat{} 2 - b * x + 3 , if 2 <= x < 3 \\ = 2 * x - a + b , if x >= 3 ; ”\end{matrix}$$

and
“the geometric series Sum(a*r̂(n−1)@(1<=n<inf) is convergent
if |r|<1;”
as well as
“for all x, ˜(member(“kingdom hall”, x)) [symbol] human(x)=>mortal(x);”
must be generated from the same set of grammar rules. As can be seen, the first sentence defines a piecewise function in a purely symbolic fashion. The second sentence, on the other hand, is a hybrid statement about the convergence radius of the geometric series, whereas the last sentence is a quantified implication written in native FOL syntax. They seem quite different structure wise, and indeed they are, and yet common patterns among them need to be established for a hybrid language. Various aspects of the present disclosure provide an establishment for common patterns among such statements.

According to some aspects of the disclosure, a “dispersion” strategy is used, instead of isolating the FOL grammar as a separated group of production rules in the language. For instance, the FOL constructs are introduced into the hierarchy of terminals and non-terminal symbols as if they were user-defined (mathematical) functions. The logical negation clause formed by the “˜” operator is treated as the same of a (algebraic) negation expression formed by the unary minus (−) operator. Implication and definition, namely, complex sentences form by “=>” and “ [symbol] ” connectives are treated as assertions and the precedence of the operators are immediately adjacent to that of the assignment operator (=). FOL constructs formed by the “ [symbol] ” and “ [symbol] ” collectives are treated as expression although they are classified as “complex sentences” in FOL grammar, and the precedence assign to the connectives is adjacent to that of multiplication (*) and addition (binary +/−) operators.

### 3.1 EXAMPLES

Various examples can generate, and thus recognize, FOL sentences in two dialects: (i) native FOL syntax for assertions in any domain including those that are beyond mathematics domain currently addressed by Leibniz; and (ii) natural math language for assertions in the domain of mathematics including algebra, pre-calculus, and single variable calculus. Such dialects are referred to herein (i) as “native” style and (ii) as “prose” style, respectively.

Several concrete examples are provided to demonstrate the definition of reasoning problems using a hybrid language that mixes simple English with mathematical expressions and the corresponding solutions. The solutions are obtained using the well-established reasoning algorithms.

To start, a determination of what FOL sentences are known axioms/conditions, and what is the conclusion to be deduced. In some examples, that is done by adding a production rule such as:

<assertion> -> “assume that” <list of assertion>
“show that” <assertion>

Note that the non-terminal symbol <assertion> can be replaced by a FOL sentence.

### 3.3.1 Examples in Native Style

The statements in Examples A and B are expressed in PL.

### Example A

The problem statement is listed below:

assume that

(a) P=>Q

(b) L [symbol] M=>P

(c) B [symbol] L=>M

(d) A [symbol] P=>L

(e) A [symbol] B=>L

(f) A

(g) B

prove Q;

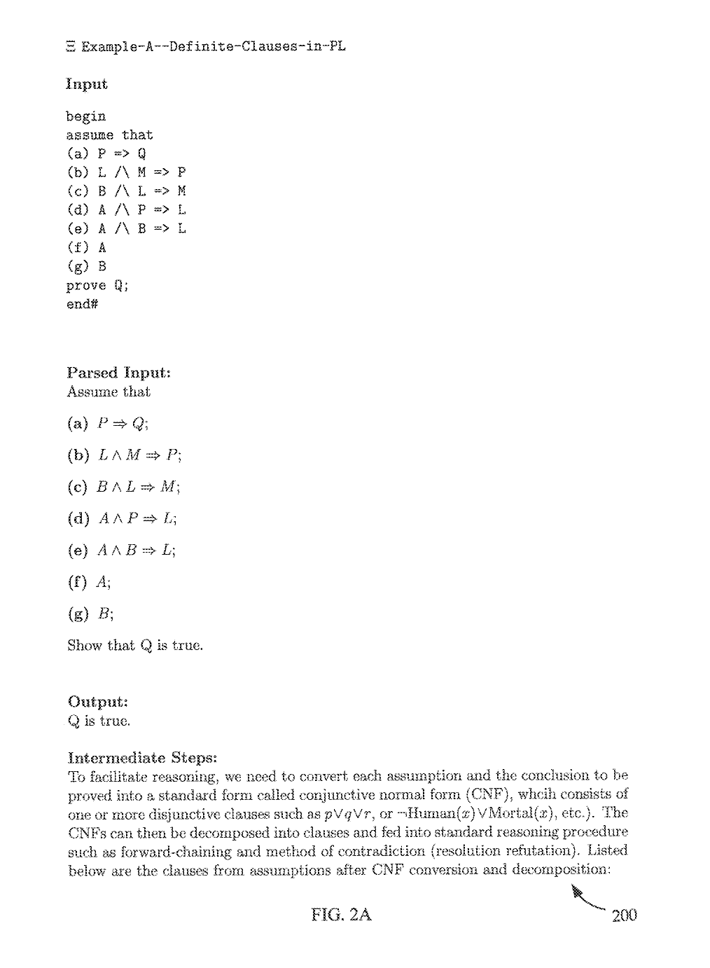

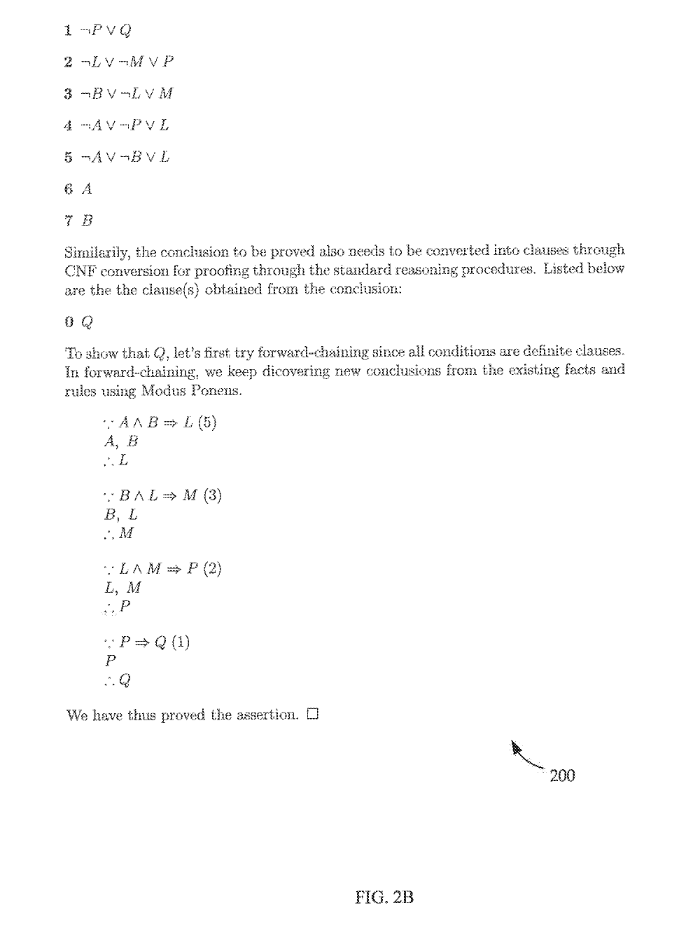

The proof uses forward-chaining based on Modus Pollens is completed in 4 steps, as can be seen from the solution listed in the example 200 of FIGS. 2A and 2B.

Several examples involving logical puzzles are now discussed. They are originally stated in English but are translated into FOL sentences manually. All the problems are solved with resolution refutation except Example F, which is solved by forward-chaining. This is because forward-chaining requires that the given conditions are all in definite clause forms (disjunction of Boolean literals with exactly one positive literal). Such a requirement is more demanding than what is required for resolution refutation, which only needs all assumptions expressed as clauses.

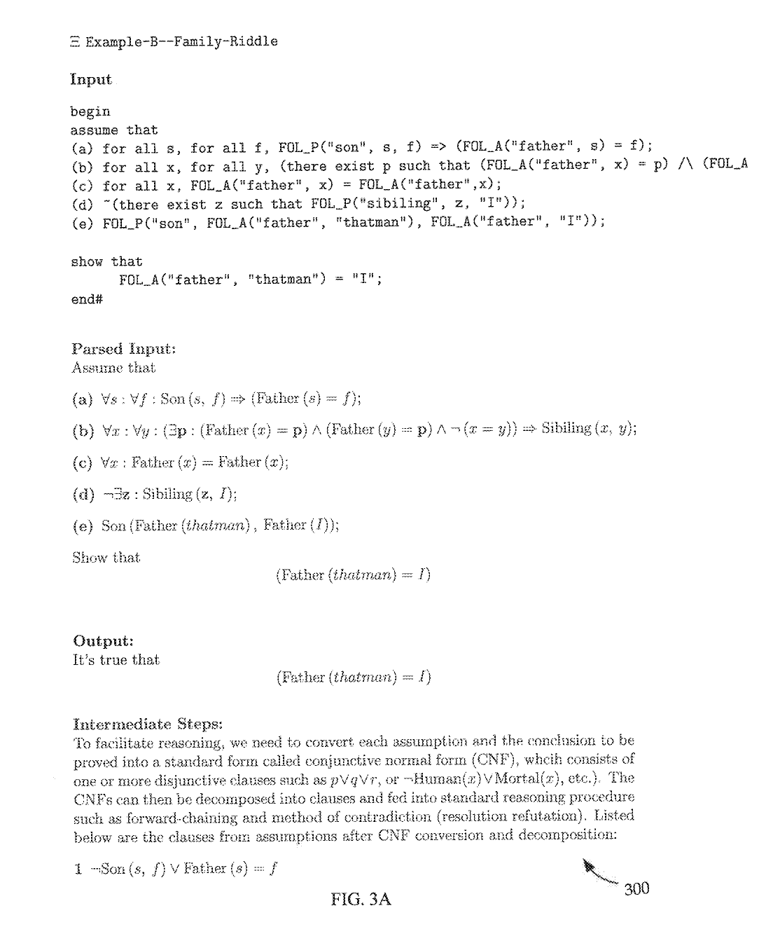

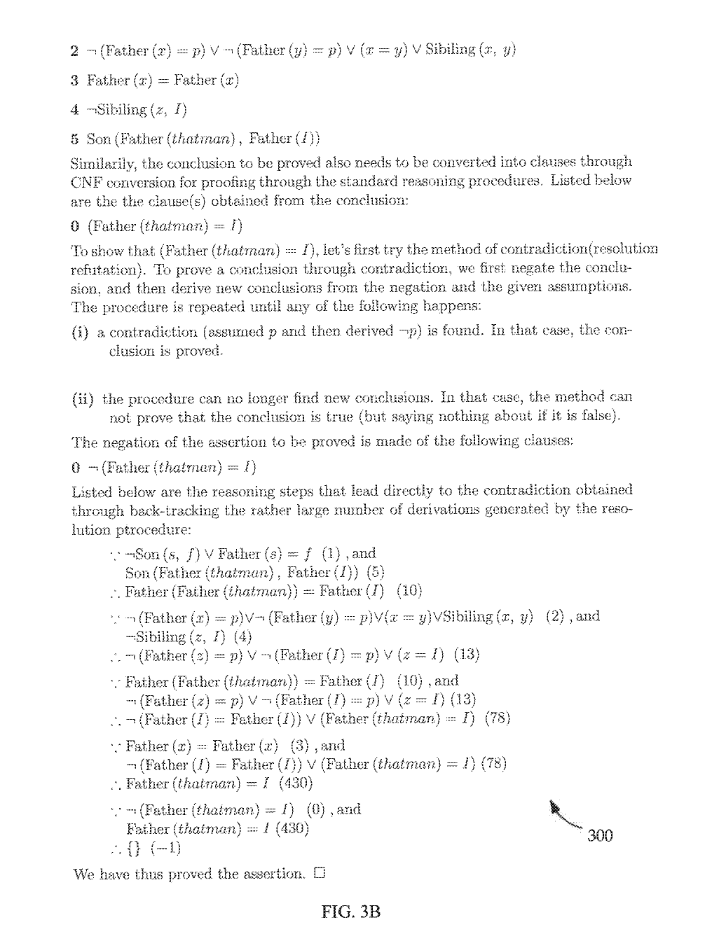

The first such example is a kinship riddle “brothers and sisters I have none, that man's father is my father's son.” This example and solution is illustrated in example 300 on FIGS. 3A and 3B. It is desired to show that “I” am that man's father. FOL function FOL_A(“father”, x) is used to represent the father of a person x, and the binary predicates FOL_P(“son”, x, y) and FOL_P(“sibling”, x, y) are used to represent the relationship for “x is y's son” and “x, y are sibling”. As can be seen, the sentences include negation and both universally quantified and existentially quantified statements.

### Example B

The problem statements in FOL are listed below.

assume that
(a) for all s, for all f, FOL_P(“son”, s, f)=>(FOL_A(“father”, s)=f);
(b) for all x, for all y, (there exists p such that (FOL_A(“father”, x)=p) [symbol] (FOL_A(“father”, y)=p)) [symbol] (˜(x=y))=>FOL_P(“sibling”, x, y);
(c) for all x, FOL_A(“father”, x)=FOL_A(“father”, x);
(d) ˜(there exists z such that FOL_P(“sibling”, z, “I”));
(e) FOL_P(“son”, FOL_A(“father”, “thatman”), FOL_A(“father”, “I”));
show that

FOL_A(“father”, “thatman”)=“I”;

It will be noted that just enough axioms (assertions that are given without proof) are used for family relationship, with a deliberate use of only a single branch of the definition for “son” and “sibling” relationship ((a), (b) are true when the implication operators (=>) are changed to equivalent operator ( [symbol] )). The reason for doing so is to decrease the spurious reasoning steps generated by the resolution refutation algorithm, is discussed in further detail below.

Also, note the implied one-to-one relation by the FOL function FOL_F(“Father”, x) must be given explicitly through the statement

for all x, FOL_A(“father”, x)=FOL_A(“father”, x)
since the FOL grammar itself does not enforce the one-to-one semantics for FOL function.
SKFᵢ( . . . ) denotes a Skolem function symbolizing an existentially quantified variable with its dependency on other variables explicitly given.

The proof for this problem using the method of contradiction and the reasoning steps leading to the contradiction is listed in FIGS. 3A and 3B.

The logical foundation for the method of contradiction is:

α|=β iff (α [symbol] [symbol] β) un-satisfiable
where α, β are FOL sentences. Simply speaking, the necessary and sufficient conditions for α|=↑(α entails β, i.e., β can be derived from α) is that α and [symbol] β can not be satisfied simultaneously. So to prove that β can be derived from α, we can first assume that β is not true (i.e., [symbol] β is true). If such assumption leads to any contradiction against α, then it can be concluded that β must be true. Notice that a can be a conjunction of FOL sentences, which is the case for most of the examples discussed herein, where the FOL sentences included in any itemized list are assumed connected to each other through conjunction ( [symbol] ).

An inference rule called resolution is used in the algorithm for method of contradiction. The basic idea is that when two FOL clauses are conjuncted (combined through [symbol] operator), the result can be formed by simply annihilating the two complement literals if any. To see why this is the case, a simple example is discussed involving unit resolution: giving p [symbol] [symbol] q, and q, it follows inevitably p.

### Example C

Hoofer's Club. The original problem in this example is from the University of Wisconsin's lecture notes (http://pages.cs.wisc.edu/˜dver/cs540/notes/fopc.html), and can be stated in English as follows:
Tony, Shikuo and Ellen belong to the Hoofers Club. Every member of the Hoofers Club is either a skier or a mountain climber or both. No mountain climber likes rain, and all skiers like snow.
Ellen dislikes whatever Tony likes and likes whatever Tony dislikes. Tony likes rain and snow. Show that there exists at least one Hoofers club member who is a mountain climber but not a skier.
   The above narratives can be expressed by the following FOL sentences:
   assume that

### (a) FOL_P(“member”, “Hoofer Club”, “Tony”);

### (b) FOL_P(“member”, “Hoofer Club”, “Shikuo”);

### (c) FOL_P(“member”, “Hoofer Club”, “Ellen”);

(d) for all x, FOL_P(“member”, “Hoofer Club”, x)=>FOL_P(“skier”, x) [symbol] FOL_P(“mountain climber”, x);
(e) for all p, FOL_P(“mountain climber”, p)=>FOL_P(“likes”, p, “rain”);
(f) for all q, FOL_P(“skier”, q)=>FOL_P(“likes”, q, “snow”);
(g) for all z, FOL_P(“likes”, “Tony”, z)=>˜FOL_P(“likes”, “Ellen”, z);
(h) for all w, ˜FOL_P(“likes”, “Tony”, w)=>FOL_P(“likes”, “Ellen”, w);
(i) FOL_P(“likes”, “Tony”, “snow”) [symbol] FOL_P(“likes”, “Tony”, “rain”);
show that
for some c, FOL_P(“member”, “Hoofer Club”, c) [symbol] FOL_P(“mountain climber”, c) [symbol] ˜FOL_P(“skier”, c);

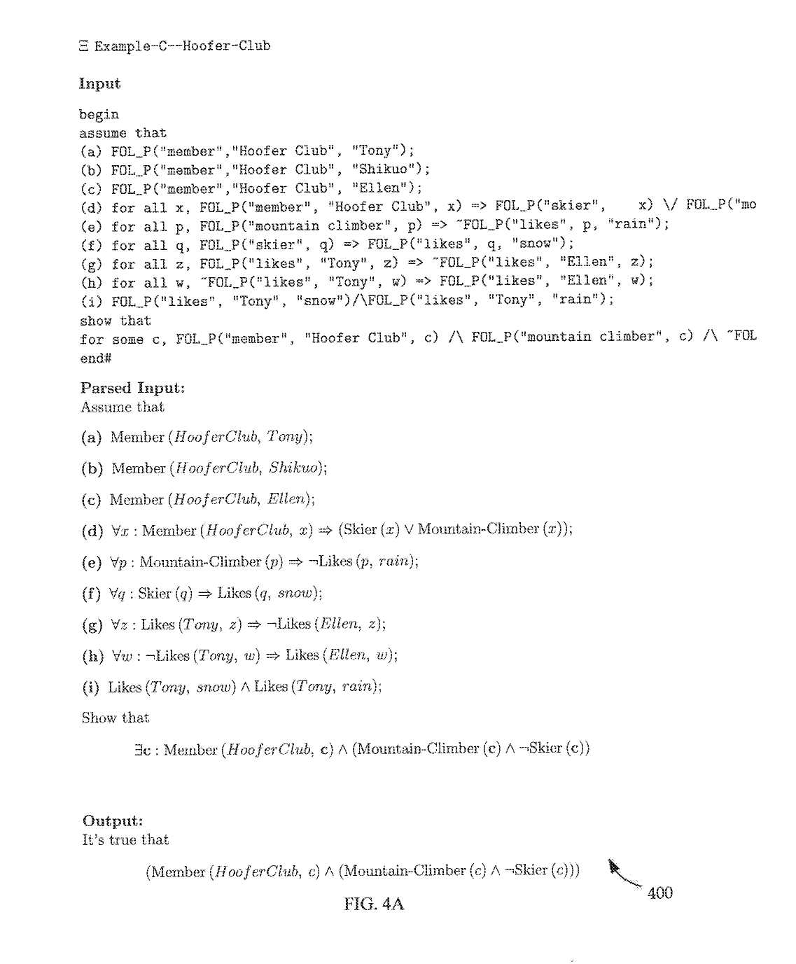

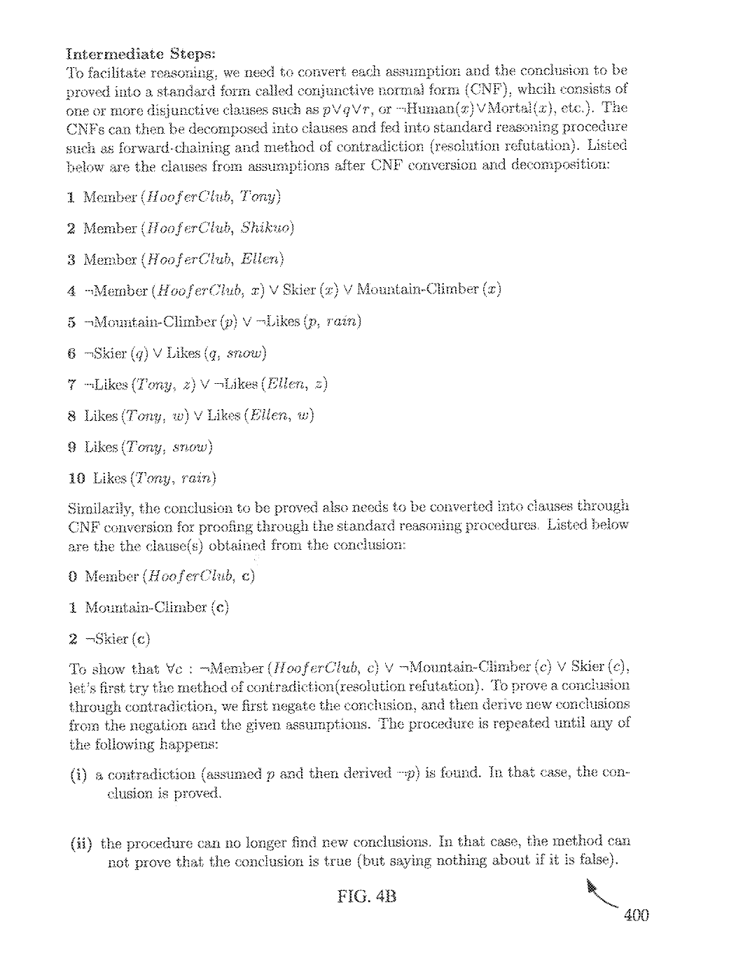

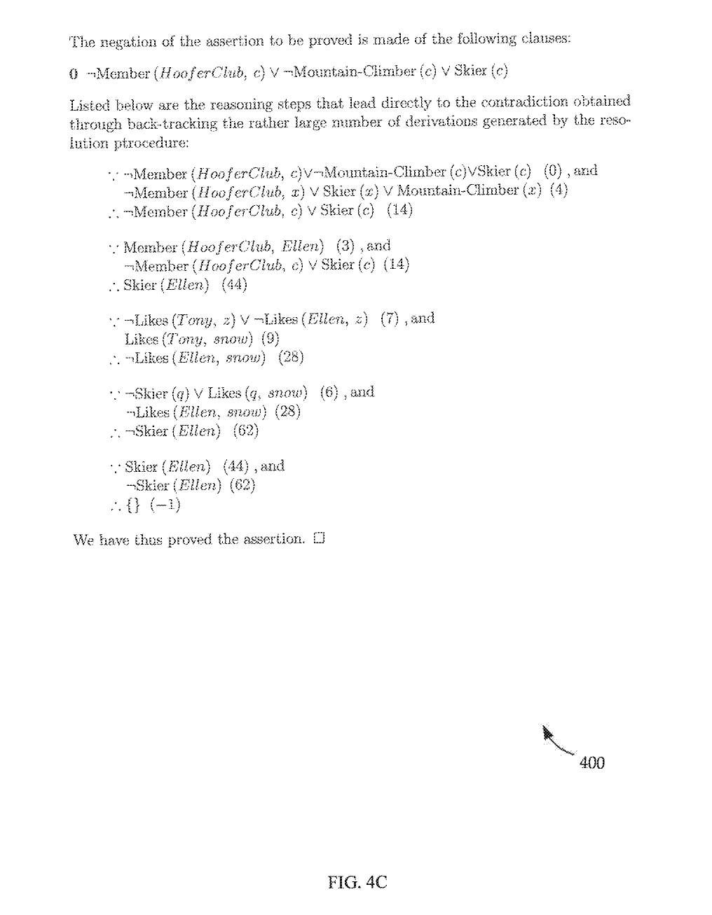

As can be seen from the output included in the example 400 of FIGS. 4A-4C, not all clauses upon conversion to conjunctive normal form (CNF) are in the form of definite clauses (a disjunction of boolean liberals with exactly one positive literal). Consequently, resolution refutation instead of forward-chaining is used to solve this problem. Note the conclusion to be proved in this example involves an existentially quantified variable c. However, upon negating the conclusion as the first step of resolution refutation, c becomes a universally quantified variable.

As can be seen, the contradiction is about whether Ellen is a skier. In a nutshell, the reasoning goes like this: Tony likes snow and Ellen dislikes whatever Tony likes, so Ellen must dislike snow. Therefore Ellen is NOT a skier since all skiers like snow. On the other hand, to satisfy the given condition (4) and the assumption (0), every member of the Hoofer club is a skier, and thus Ellen must be a skier, which contradicts to the derived assertion that Ellen is NOT a skier.

Similar to forward-chaining, many irrelevant resolutions are performed by the refutation algorithm although only a few of them lead to the proof (i.e. the contradiction). It should be noted that several heuristics exist for improving the efficiency of the resolution refutation algorithm.

### Example D

Jack Did Not Kill the Cat. The original problem of this example is from Stuart Russell, Peter Norvig, 2003, Artificial Intelligence—A Modern Approach, Chapters 9, Prentice Hall, and is stated in English as follows:
Everyone who loves all animals is loved by someone;
Anyone who kills an animal is loved by no one;
Jack loves all animals;
Either Jack or Curiosity killed the cat, who is named Tuna;
Show that Jack did not kill the cat;
   The FOL representation is:
   assume that
   (a) for all x, (for all y, FOL_P(“animal”, y)=>FOL_P(“loves”, x, y))=> for some alpha, FOL_P(“loves”, alpha, x);
   (b) for all x, (for some beta, FOL_P(“animal”, beta) [symbol] FOL_P(“kills”, x, beta))=>˜(for some gamma, FOL_P(“loves”, gamma, x));
   (c) for all y, FOL_P(“animal”, y)=>FOL_P(“loves”, “Jack”, y);
   (d) FOL_P(“kills”, “Jack”, “Tuna”) [symbol] FOL_P(“kills”, “Curiosity”, “Tuna”);

### (e) FOL_P(“cat”, “Tuna”);

(f) for all y, FOL_P(“cat”, y)=>FOL_P(“animal”, y);
show that ˜FOL_P(“kills”, “Jack”, “Tuna”);

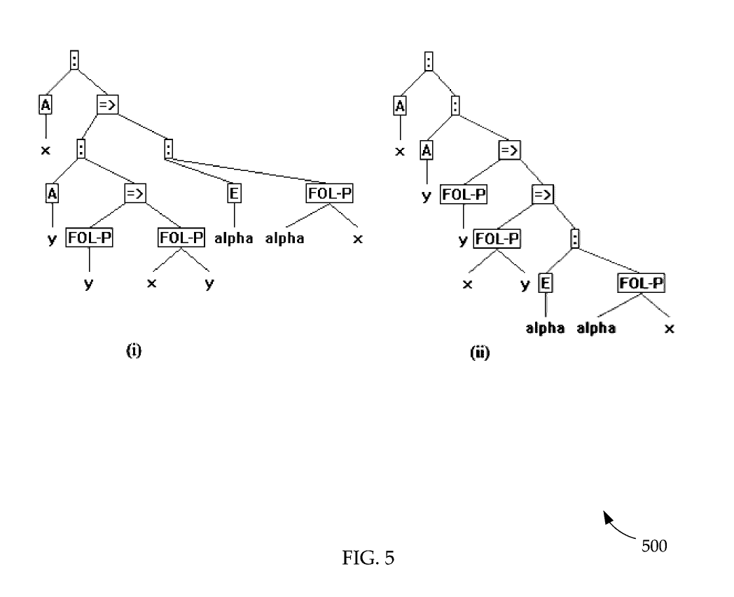

Note that, in this example, parentheses are used to control the scope of the quantification imposed on y in sentence (a). The abstract-syntax-tree (AST) for the sentence and the AST for the same sentence but without the parentheses are shown in FIG. 5 side-by-side for comparison.

If the subtle differences in the semantics carried by the 2 sentences above may not be so obvious, the differences are quite clear in the corresponding clause forms after both sentences are converted to CNF: for the case with parentheses, the CNF of the sentences is a conjunction of 2 disjunctive clauses:
Animal(SKF3(x)) [symbol] Loves(SKF4(x),x)
[symbol] Loves(x,SKF3(x)) [symbol] Loves(SKF4(x),x)
   whereas for the case without parentheses, the CNF only contains one disjunctive clause.
[symbol] Animal(y) [symbol] [symbol] Loves(x,y) [symbol] [symbol] Loves(SKF2(x,y),x)

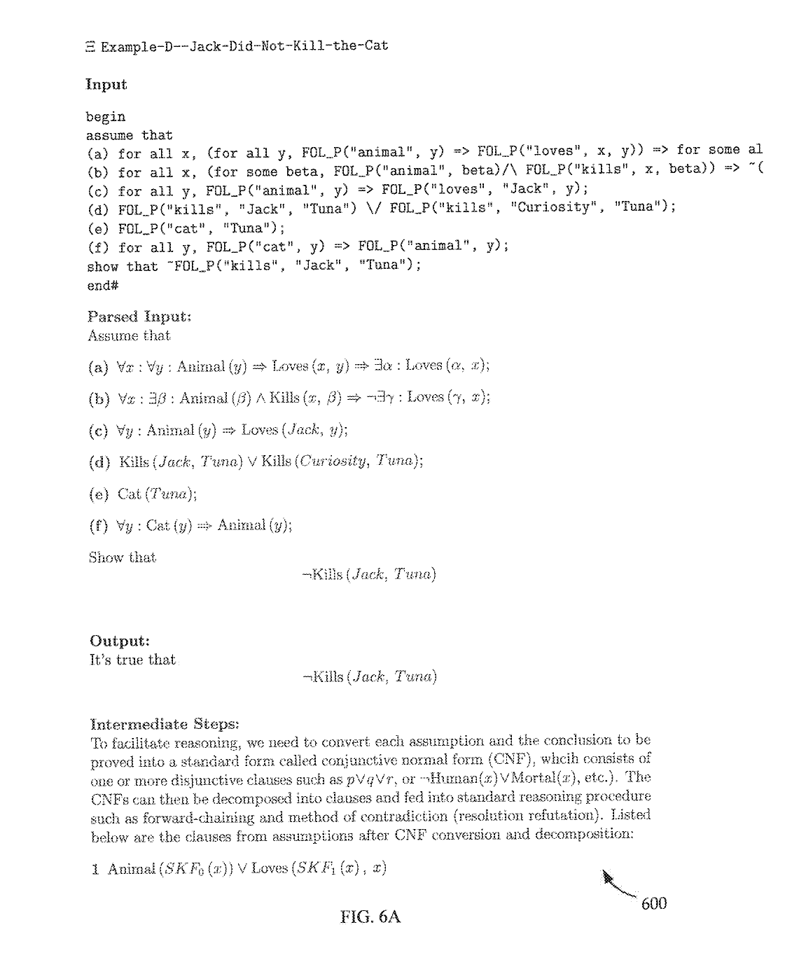

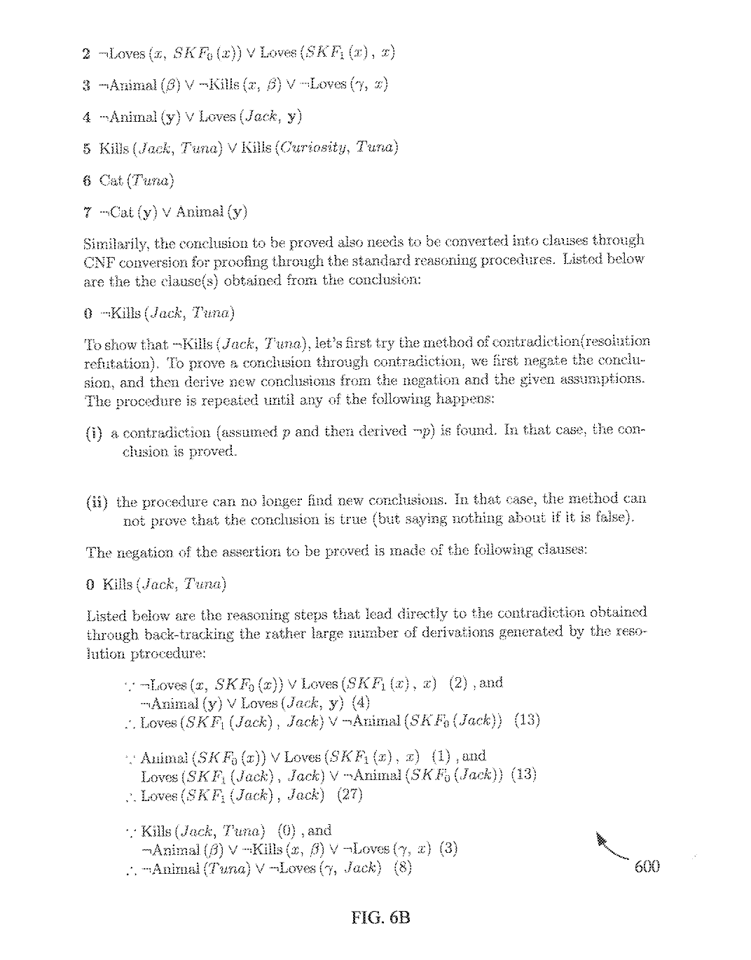

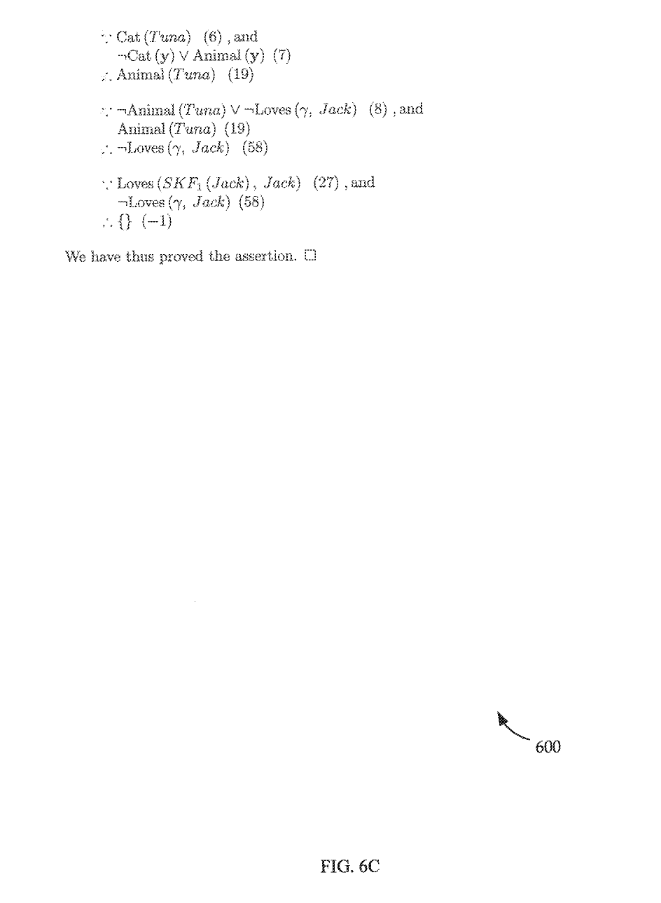

As mentioned, FIG. 5 illustrates a comparison of AST for sentence (a) in Example D and the AST of the same sentence after parentheses enclosing the premise for the outmost implication is removed. The proof is given in the example 600 illustrated in FIGS. 6A-6C

### Example E

Marcus Hated Cesar. The example is originally from Boris Stilman's AI course notes (http://www.stilman-strategies.com/bstilman/teaching/AI.html), which written in English is listed below:

Marcus was a man;

Marcus was a Pomperian;

All Pomperians were Romans;

Caesar was a ruler;

All Romans were either loyal to Caesar or hated him;

Everyone is loyal to someone;

Persons only try to assassinate rulers they are not loyal to;

Marcus tried to assassinate Caesar;

Show that Marcus hated Caesar;

The corresponding FOL representation is:
assume that

### (a) FOL_P(“man”, “Marcus”);

### (b) FOL_P(“Pomperian”, “Marcus”);

(c) for all x, FOL_P(“Pomperian”, x)=>FOL_P(“Romans”, x);

### (d) FOL_P(“ruler”, “Caesar”);

(e) for all x, FOL_P(“Romans”, x)=>FOL_P(“loyal to”, x, “Caesar”) [symbol] FOL_P(“hate”, x, “Caesar”);
(f) for all x, for some alpha, FOL_P(“man”, x) [symbol] FOL_P(“man”, alpha)=>FOL_P(“loyal to”, x, alpha);
(g) for all x, for all y, FOL_P(“person”, x) [symbol] FOL_P(“ruler”, y) [symbol] FOL_P(“assassinate”, x, y)=>˜FOL_P(“loyal to”, x, y);

### (h) FOL_P(“assassinate”, “Marcus”, “Caesar”);

(i) for all x, FOL_P(“man”, x)=>FOL_P(“person”, x);
show that FOL_P(“hate”, “Marcus”, “Caesar”);

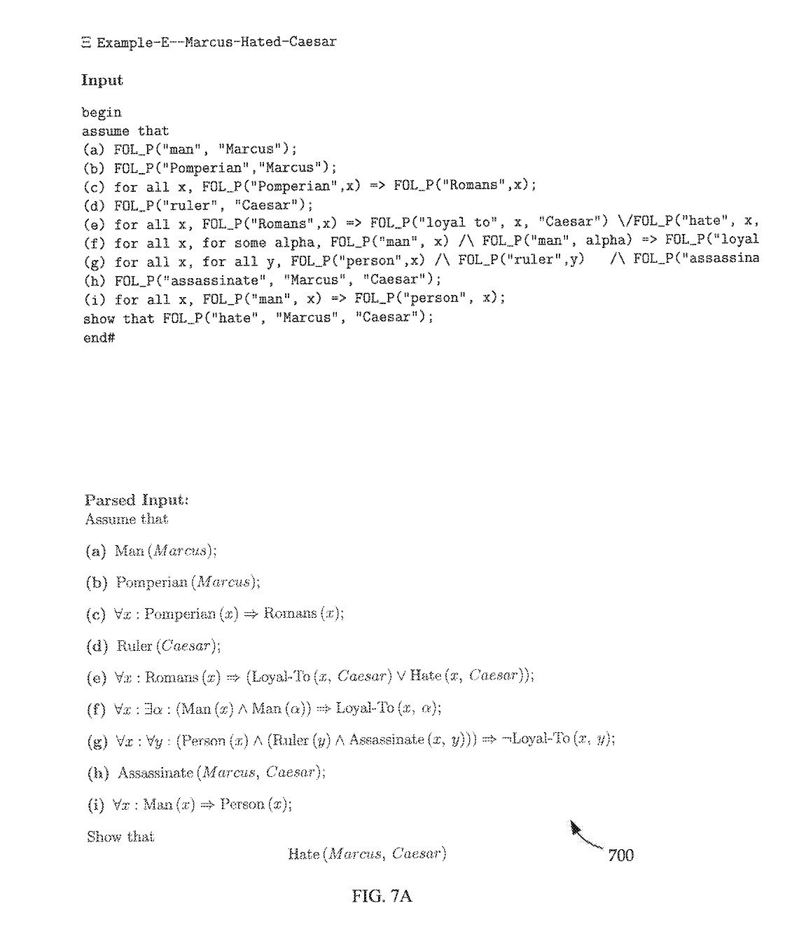

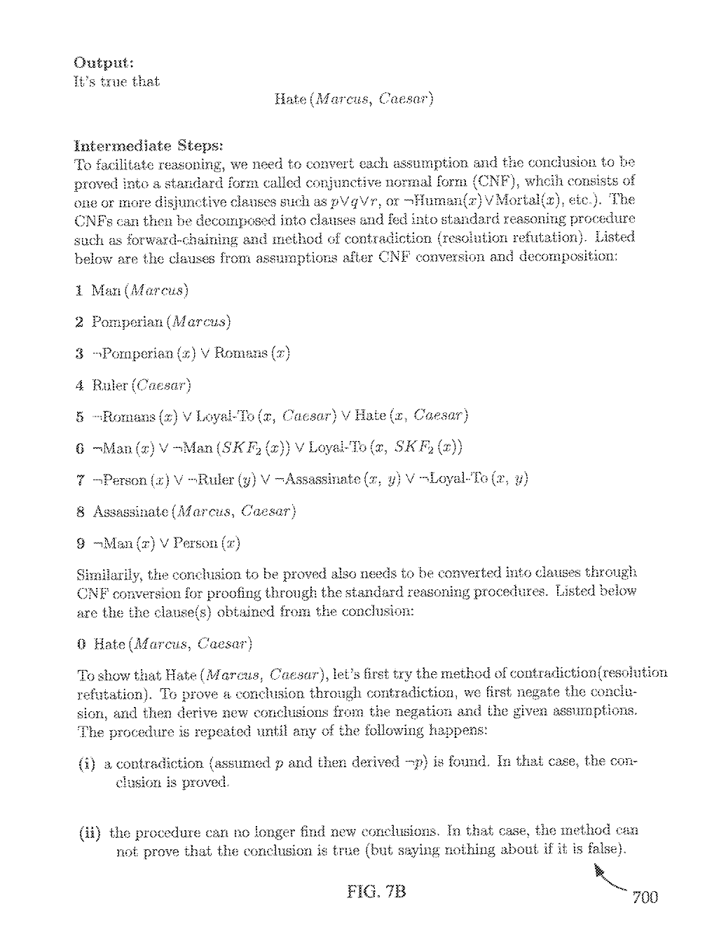

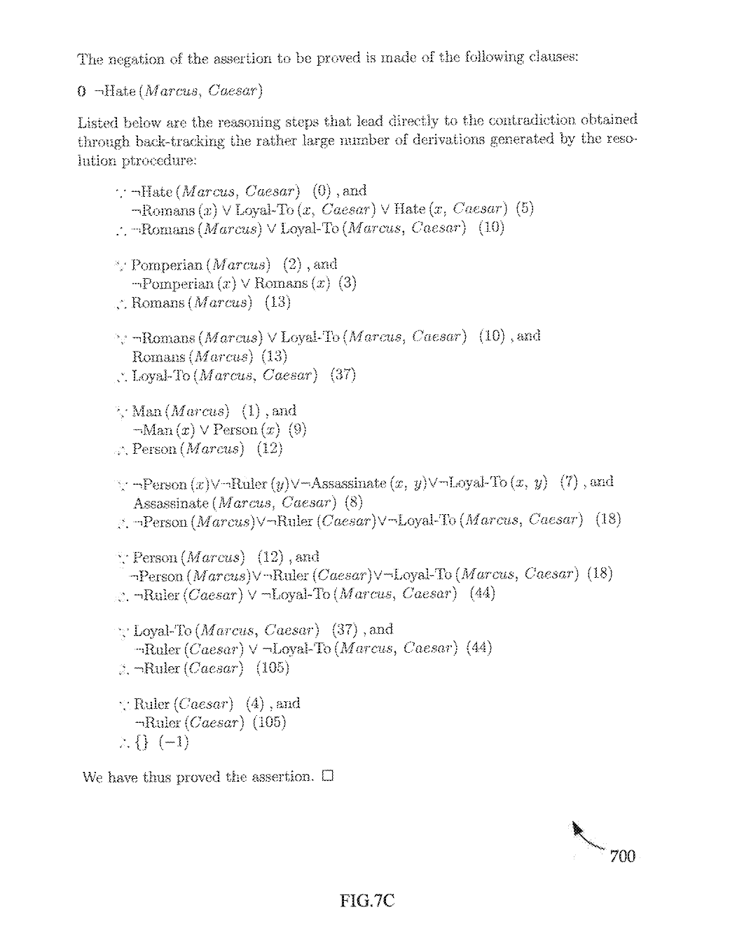

The proof is given in the example 700 illustrated in FIGS. 7A-7C

### Example F

West is a Criminal. The original problem of this example is also from Stuart Russell, Peter Norvig, 2003, Artificial Intelligence—A Modern Approach, Chapters 9. Prentice Hall, which stated in English is as follows:
The laws say that it is a crime for an American to sell weapons to hostile nations. The country Nano, an enemy of America has some missiles, and all of its missiles were sold to it by Colonel West, who is American. Show that West is a criminal.
   Upon translation, the problem can be expressed as:
   assume that
   (a) for all x, for all y, for all z, FOL_P(“American”, x) [symbol] FOL_P(“Hostile”, y) [symbol] FOL_P(“Weapon”, z) [symbol] FOL_P(“Sell”, x, y, z)=>FOL_P(“Criminal”, x);

### (b) FOL_P(“Enermy”, “Nano”, “America”);

(c) for some w, FOL_P(“Missle”, w) [symbol] FOL_P(“Owns”, “Nano”, w);
(d) for all m, FOL_P(“Owns”, “Nano”, m)=>FOL_P(“Sell”, “West”, “Nano”, m);

### (e) FOL_P(“American”, “West”);

(f) for all N, FOL_P(“Enemy”, N, “America”)=>FOL_P(“Hostile”, N);
(g) for all p, FOL_P(“Missle”, p)=>FOL_P(“Weapon”, p);
show that FOL_P(“Criminal”, “West”);

Forward-chaining for sentences written in FOL is more complex than that for sentences written in PL. Like resolution refutation, the algorithm uses unification—series of substitutions that make two predicates look identical, in searching facts that can satisfy a rule (implication) to derive a new conclusion.

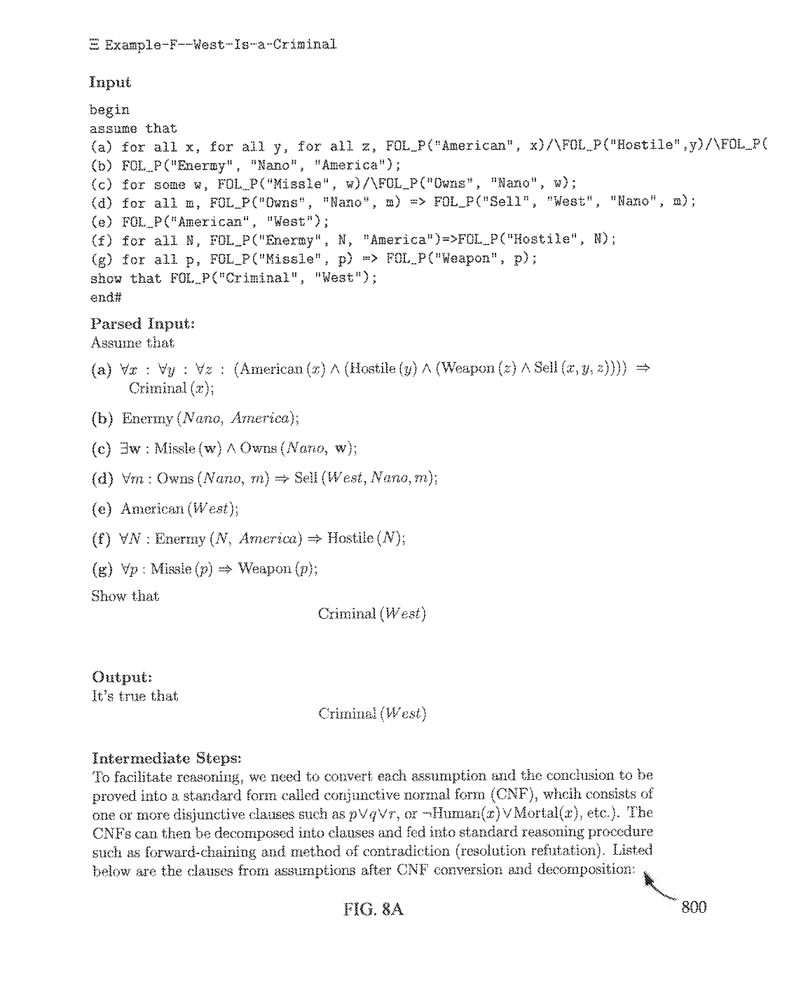

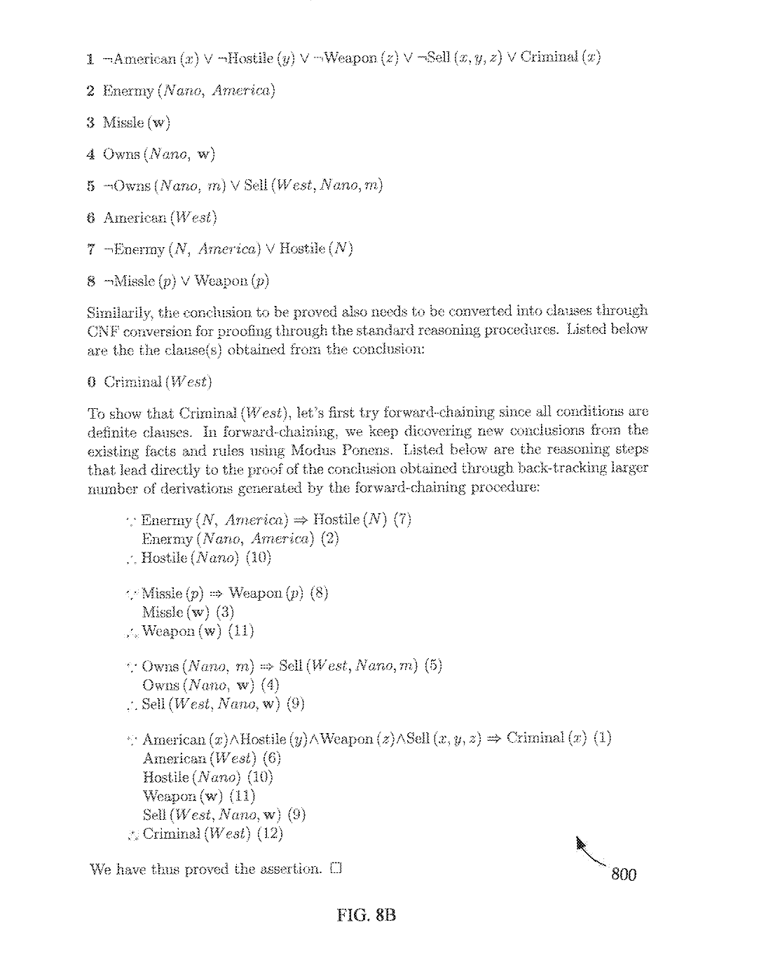

The proof is given in the example 800 illustrated in FIGS. 8A-8B

### 3.3.2. Examples in Prose Style

While FOL is efficient for expressing mathematical statements, it's rare that people write mathematics or define problems in strictly FOL syntax. Instead, people use hybrid sentences that mix English prose with embedded symbolic expressions—the prose style as referred to herein. Normally, the structural signatures such as implications (if . . . then . . . , . . . implies . . . ) and quantifications (for all x . . . , for some c . . . ) is evident, but the descriptive declarations and relations between entities are hidden in English sentences and phrases rather than expressed in FOL predicts and FOL functions. As a result, semantic routines associated with grammar rules need to capture the hidden structures and generate the corresponding FOL constructs.

According to various aspects, problems defined in “prose” style are first translated into FOL presentation automatically by the software.

The domain constraint associated with this style means that the vocabulary is limited to what is commonly included for the aforementioned mathematics domains. For instance, while the various examples of the computer language understands (or more precisely, recognizes) the word “limit” in the sense of Weierstrass's ε/δ language, it does not recognize that “father” means a male who has at least one offspring. Below is a simple example of assertions expressed in this style:

the matrix ((0, −i), (i, k)) is unary
The interpreter according to various aspects will generate the following FOL sentence from it:

### FOL_P(“unary”, (((0, −i), (i, k))

which can be considered as a constraint imposed on the variable k. Notice the argument—a nested list is a single mathematical entity, or in FOL terminology, a term.

Theorems are rules that are universally applicable within its intended domain(s). In various aspects of the computer language described herein, they can be entered using either the “native style” or the “prose style,” or both. In some examples such theorems may be treated just as regular statements except that after interpretation, they become what is referred to as system knowledge (like certain grammar and lexicon(s)) that can be accessed and used by any users.

Theorems can be entered one-by-one or in a mini-ensemble where several related theorems are entered together. The theorem statement, in various examples, is accented with a key word “theorem” or “definition” followed by a short phrase naming the theorem. In some examples, it is still a perfectly legal statement even after the key word and the parenthesized label are removed, although the statement will no longer holds the status as a theorem. It is not consequential whether the statement is called “theorem” or “definition,” which is just a convention to label theorems that are logically implications (“=>” or “imply|implies” or “if . . . then”), and theorems that are equivalences (“<=>” or “iff” or “mean|means” or . . . if|iff”).

Listed below is an example for defining several theorems that are related to limit. Note that a list of assertions is assumed to be conjunctive, meaning its member statements are connected through the “and” ( [symbol] ) connective.

### Example G

Several theorems in single-variable calculus.

definition(“continuity definition”): for all function f, f is continuous at x_0 iff
(a) f(x_0) is defined;
(b) lim(f(x))@(x->x_0) is defined;
(c) lim(f(x))@(x->x_0)=f(x_0);
theorem(“continuity differentiability theorem”): for all function f, if f is differentiable at x_0, then f is continuous at x_0;
definition (“definition of limit”):for all function f, lim(f(x))@(x->x_0) is defined iff
(a) lim(f(x))@(x->x_0̂+) is defined;
(b) lim(f(x))@(x->x_0 ̂−) is defined;
(c) lim(f(x))@(x->x_0̂+)=lim(f(x))@(x->x_0 ̂−);
definition (“The epsilon/delta definition of limit”): for all function f, for all x_0, lim(f(x))@(x->x_0)=L iff
(a) for some interval I, (x_0 {I) [symbol] FOL_P(“defined”, f, I\{x_0});
(b) for all epsilon, for some delta, ((epsilon >0) [symbol] (delta >0) [symbol] |x−x_0|<delta)=>|f(x)−L|<epsilon;
end#

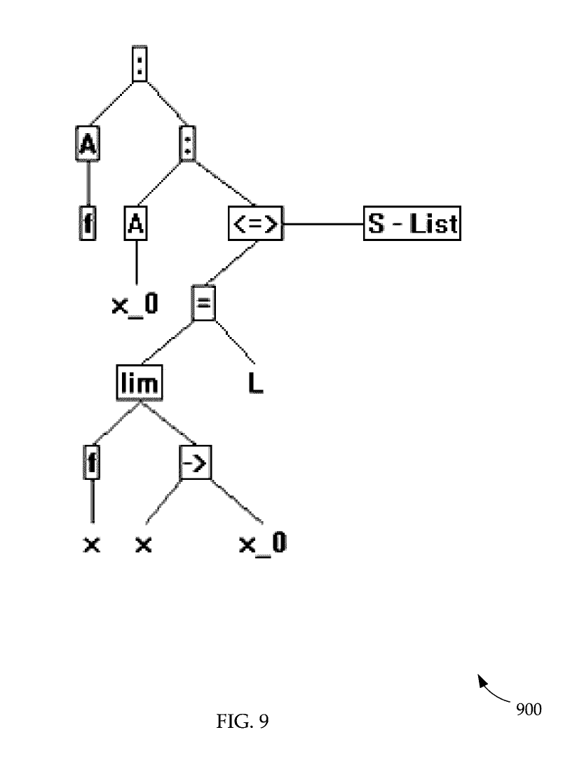

The AST 900 of the last definition is drawn is FIG. 9, where “S-List” refers to the two conditions (a) and (b). Notice that “A” is used for denoting the universal quantifier ∀ and “E” is used for denoting the existential quantifier ∃ in the tree.

As can be seen, the definition states the equivalence between the existence of the limit of a function and its micro-behavior in a small neighborhood around the location where the limit is considered. There are two conditions: First, there must exist some intervals around x_0, which may or may not include x_0 itself, such that the function is defined:

for some interval I, (x_0 {I) [symbol] FOL_P(“defined”, f, I\{x_0});
Second, the function can get arbitrarily close to the limit (L) as is desired, which is fully articulated by
for all epsilon, for some delta, ((epsilon >0) [symbol] (delta >0) [symbol] |x−x_0|<delta)=>|f(x)−L|<epsilon.

The readability of the theorem, in some instances, may be deteriorated somewhat when compared to what are stated in calculus textbooks, but the FOL representation is well structured with explicitly declared quantifications, and can be used to drive the procedure for determining the existence of limits of functions.

For comparison, the statement of the theorem by/in Stewart (James Stewart, 2008, “Single Variable Calculus—Early Transcendentals for UC Berkeley,” p 110, Cengage Learning) is listed:

Theorem: Let f be a function defined on some open interval that contains the number a, except possibly at a itself. Then we say that the limit of f(x) as x approaches a is L, and we write
lim(f(x))@(x->a)=L
   if for every number ε>0 there is a number δ>0 such that
if 0<|x−a|<δ then |f(x)−L|<ε.
   With function f and x-value x_0 being assumed universally quantified implicitly, the statements can be expressed as

p=>(q=>r)

where p, q denote the two conditions that are defined in our version of the theorem (see above), and r denotes the assertion lim(f(x))@(x->a)=L.

It should be noted that when a particular theorem is invoked during reasoning or problem solving, it will be recompiled and standard variable standardization procedure will be invoked to resolve any symbol conflict.

Users, in some aspects of the disclosure, may define their own theorems using the same statements. A consistency check is performed against the theorems that have already been defined, in some examples, to avoid redundancy and inconsistency (satisfiability). Such design makes it relatively easy for math and CS students to develop their own axiom systems in learning logical reasoning.

Next discussed are two reasoning examples in single-variable calculus. The first involves the connection between limit, continuity, and differentiability, and the second involves proving an assertion through the mean-value-theorem.

### Example H

Differentiability and Limit. This is a simple reasoning exercise involving limits, continuity and differentiability. The problem is defined as following:

assume function g is differentiable at a;

show that
lim(g(x))@(x->â+)=lim(g(x))@(x->â−);

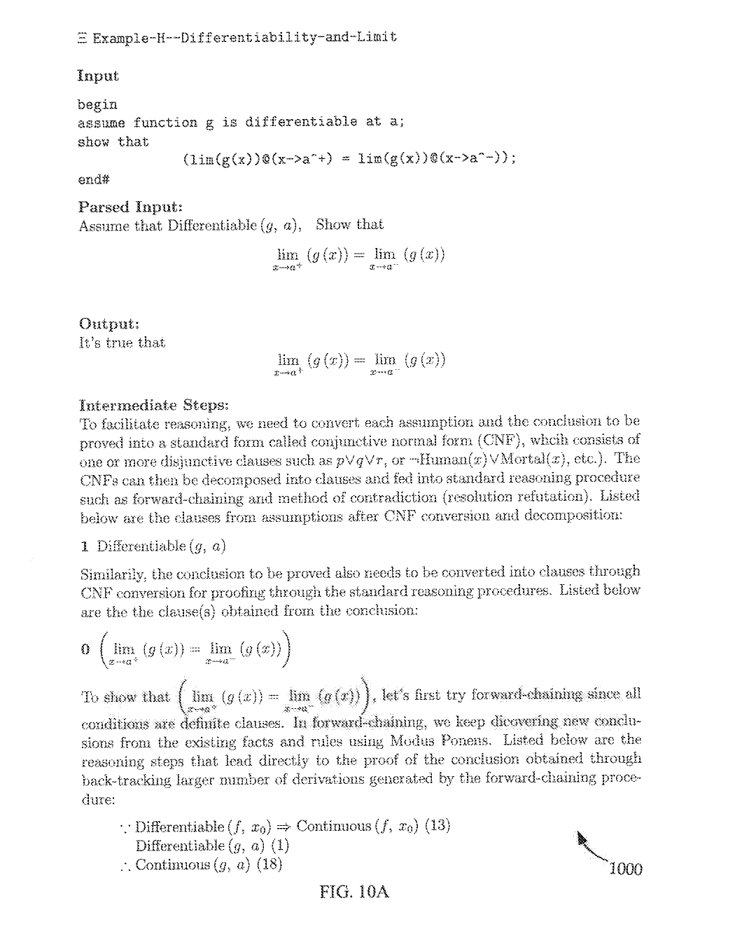

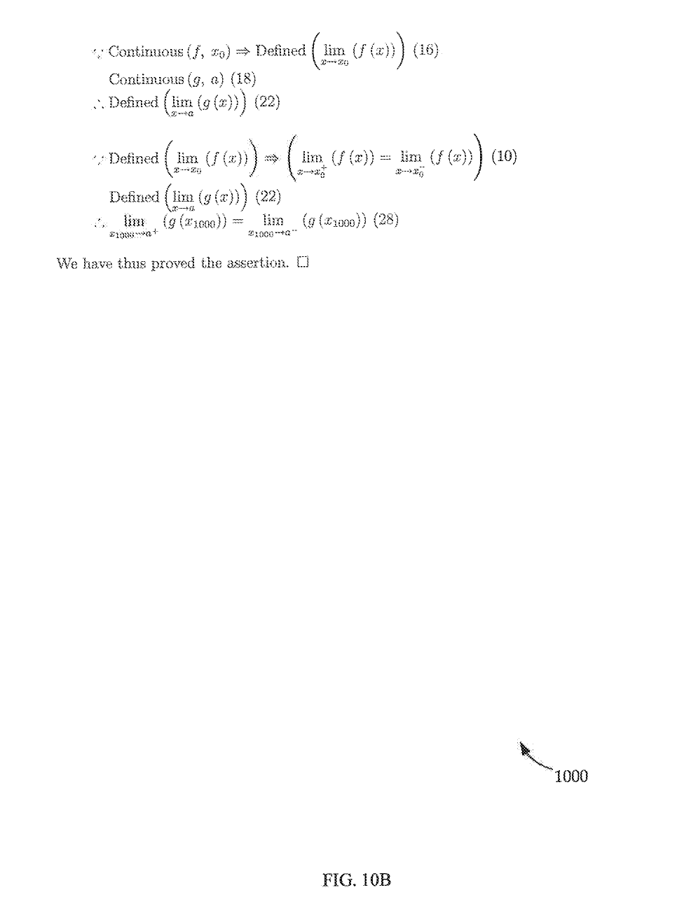

The proof is carried out, as indicated in example 1000 of FIGS. 10A-10B, using forward-chaining, which in its final form involves three steps: First, the function is differentiable at a, thus it must be continuous at a. Second, the continuity of g at a implies that the limit off must be defined at the same location a. Third, from the existence of the limit, it follows that the 2 single-sided limits off as x approaching a aleft and aright must be equal.

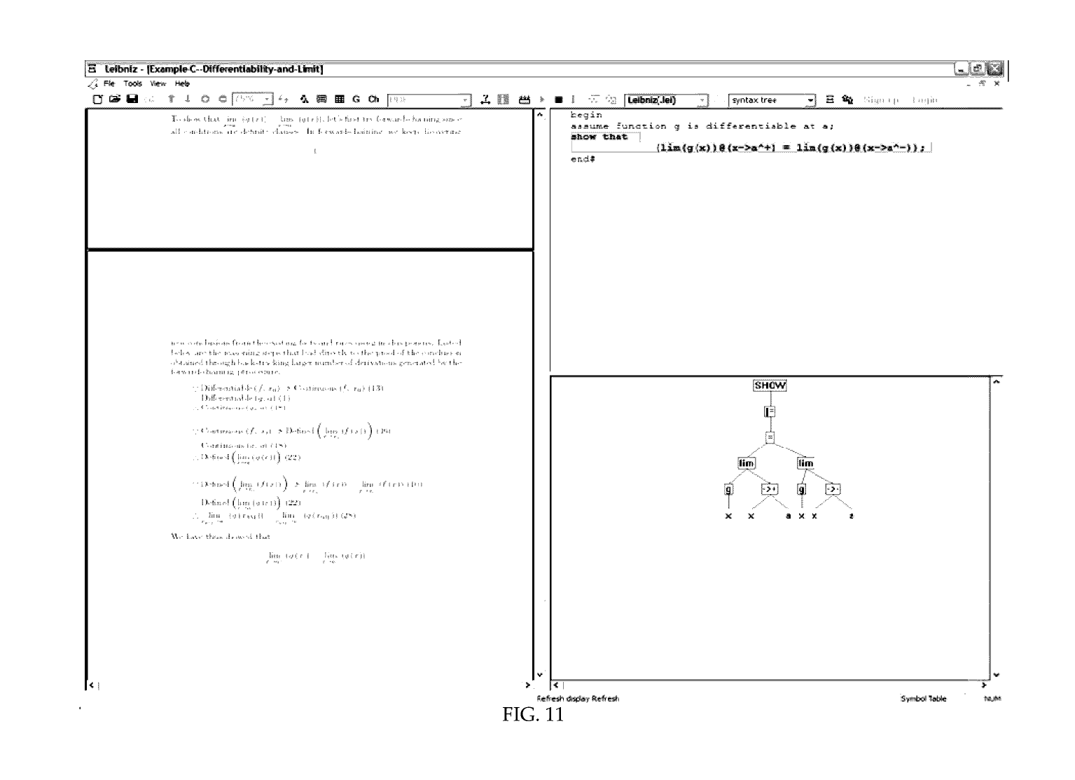

One may notice from the screenshot 1100 of this example, from the interpreter, as indicated in FIG. 11, that the left branch to the entailment operator (“|=”) in the AST for the deduction statement is empty. That is intentional since it is unknown what theorems will be needed to derive the conclusion other than the given assumptions.

It is worthwhile to point out that the internal representation for limit has been changed such that the approaching operator now bearing the information about its approaching direction, aleft, aright, or from both, as illustrated in FIG. 11, for approaching from left, it is represented by “−>−”, and when approaching from right, it is represented by “−>+”, and simply “−>” when approaching from both sides. That is more reasonable than attaching the approaching direction info to the postfix operator that is applied to location (a, x_0, etc). This is because, when an operator including postfix operator is applied to its operand, it is expected that some decisive modification taking place to the value of the operand (example ĉ*, where c is a complex number). This expectation certainly does not match what the “̂+” operator means in the expression lim(f(x))@(x->â+). Indeed if applying the common interpretation of ̂+ as a postfix operator to, for example, a, lim(f(x))@(x->â+) it would simply mean the limit of f(x) as x approach â+, a fixed location somewhere very close to but always above a. Does x->â+ tell from which direction it approaches â+, not really. Nevertheless, this syntax for limit is maintained unchanged in some examples because it may be desirable to keep it to be similar to what is used with natural math notation.

One may also notice that the consequent (28) from the last reasoning step of FIG. 11 reads

lim(g(x₉₃₁))@(x₉₃₁−>â+)=lim(g(x₉₃₁))@(x₉₃₁−>â−),
and it may be concluded that the assertion is proved despite that it differs slightly from the goal statement, where the variable name is x instead of x₉₃₁. This is because universally quantified variables x₉₃₁ and x are dummy variables or bound variables in both contexts. Namely, it really does not matter if the variable is named x or x₉₃₁ or John for that matter, since they will be bound to a particular value or values and consequently, the semantics of the mathematical statements will not be altered.

x₉₃₁ is created at the beginning of the last reasoning step when variable standardization is invoked to avoid symbol conflicts between statement (10), which is a theorem automatically loaded, in some examples, by the reasoning engine, and a derived fact (10).

### Example I

Application of Lagrange's Mean-Value-Theorem. The problem is defined by the following statements in an exemplary language, such as Leibniz:

g is a function;

alpha, beta, m, M are constant;

assume that

(a) g is continuous on [alpha, beta];

(b) g is differentiable on (alpha, beta);

(c) for all x_0, x_0 {(alpha, beta)=>m<(d/dx)g(x)@(x=x_0)<M;

(d) u {(alpha, beta);

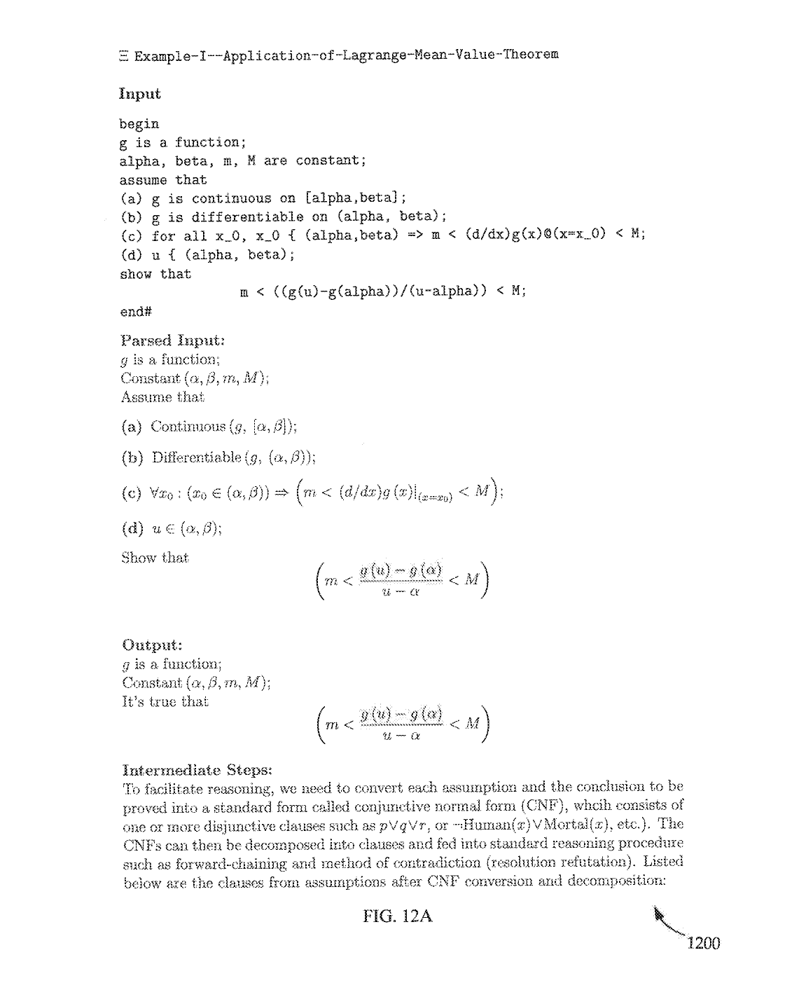

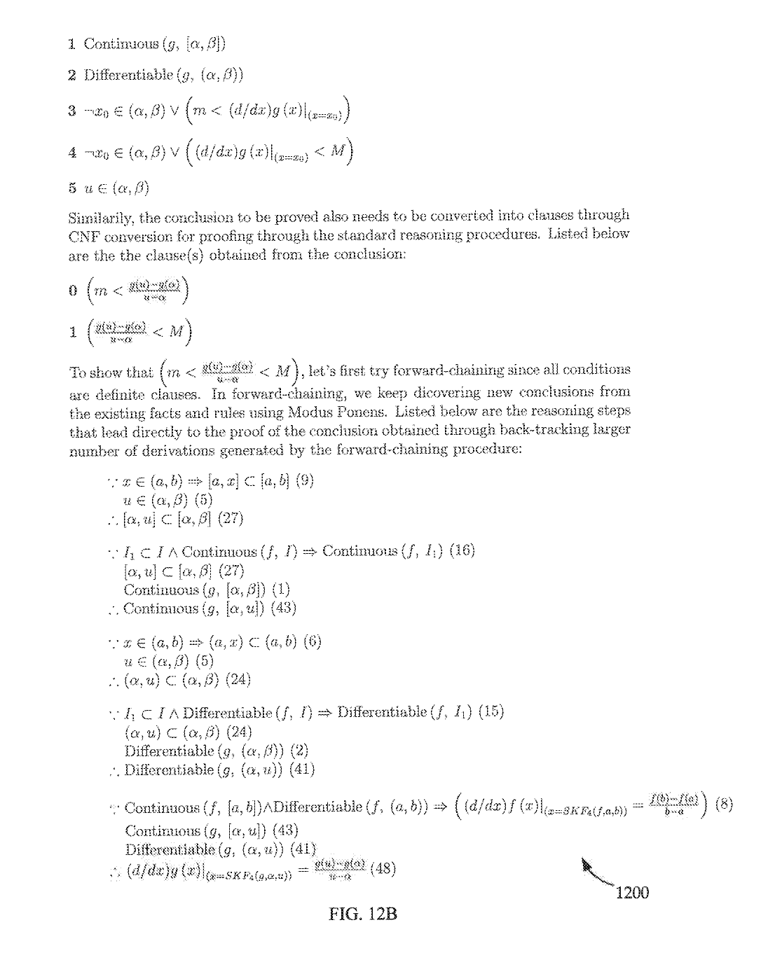

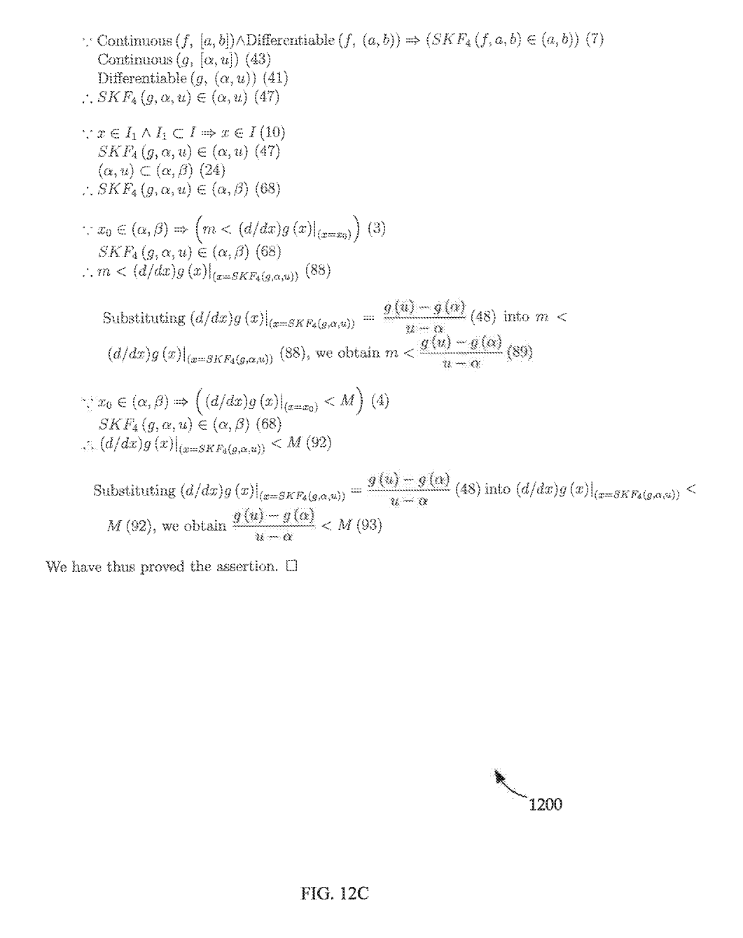

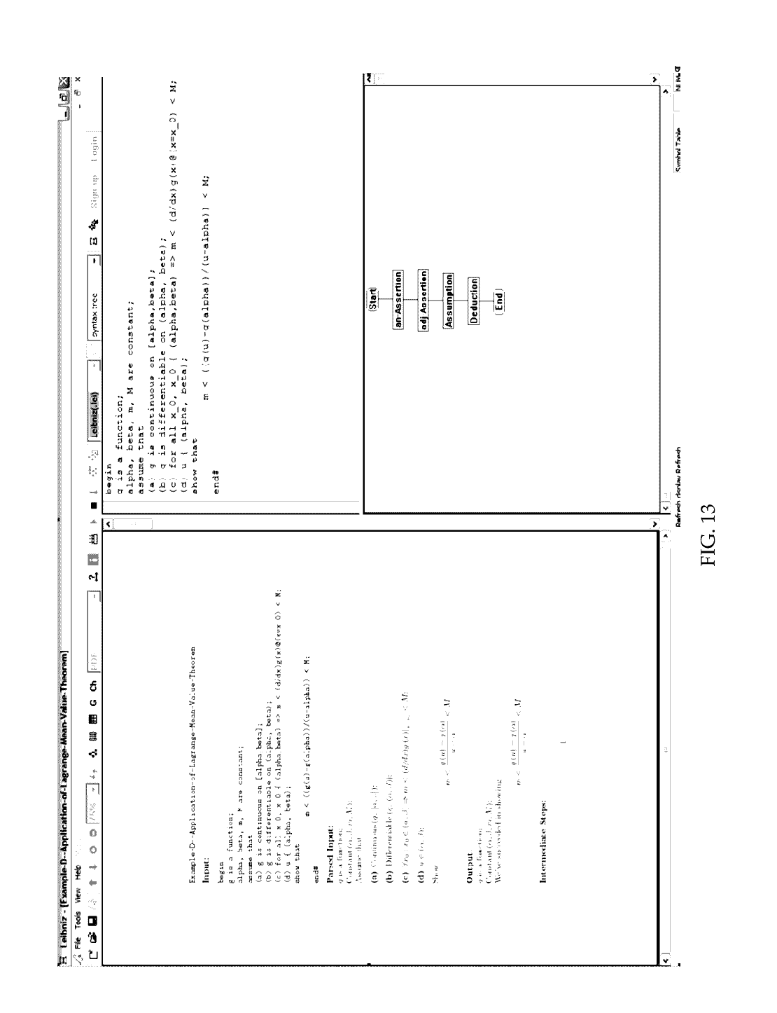

show that
m<((g(u)−g(alpha))/(u-alpha))<M;
   The solution 1200 is presented in FIGS. 12A-12C, and a screenshot 1300 from the interpreter showing the first page of the output and the flow diagram is given in FIG. 13. Notice only 7 reasoning steps (5 applications of modus ponens and 2 demodulations) are actually needed to derive the conclusion, although the reasoning algorithm carries out far more derivations. As can be seen, the reasoning involved is more complex than what is involved in Example H of FIGS. 11A-11B, since it uses demodulation in addition to forward-chaining. Demodulation is an inference procedure that involves the application of equality derived to other assertions that contain sub-expressions included in the equality. In this example, the equality equates the derivative of a function at a specific location within an interval and the function values evaluated at the boundary of the interval, and the assertions that it applies to include the inequalities that bound the value of the derivative.

The problem involves existentially quantified variable, which as was discussed earlier, is not handled directly by various other available programs, such as Prolog.

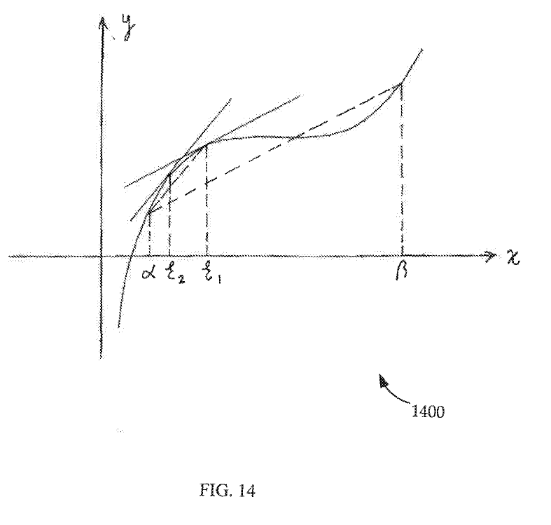

It should be noted that the application of the mean-value-theorem can lead the reasoning engine into an infinite loop, as indicated in the example 1400 of FIG. 14. This is because the premises for the theorem are satisfiable in any of the sub-intervals within the initial interval, the reasoning algorithm will continue to apply the mean-value-theorem in smaller and smaller intervals. Accordingly, the type of theorems that will result in this type of unwanted repetitions may be identified in order to prevent an infinite loop from happening.

The solution provided in some examples to this relatively straightforward reasoning problem is automatically including the selection of relevant axioms/theorems. Potential obstacles that may prevent the reasoning engine from solving more complex problems will be likely due to the “little algebra” involved in demodulation—there are more than one possible substitutions exist that can be made from a single equality, when the equality contains more then one variable. The question is then what heuristics should be selected to reach the goal statement, and reach it fast if it is reachable at all.

Also notice that there is no hint is given regarding what theorems need to be used to prove the goal statement. The reasoning engine has to decide what theorems are likely to be relevant and then load them subsequently.

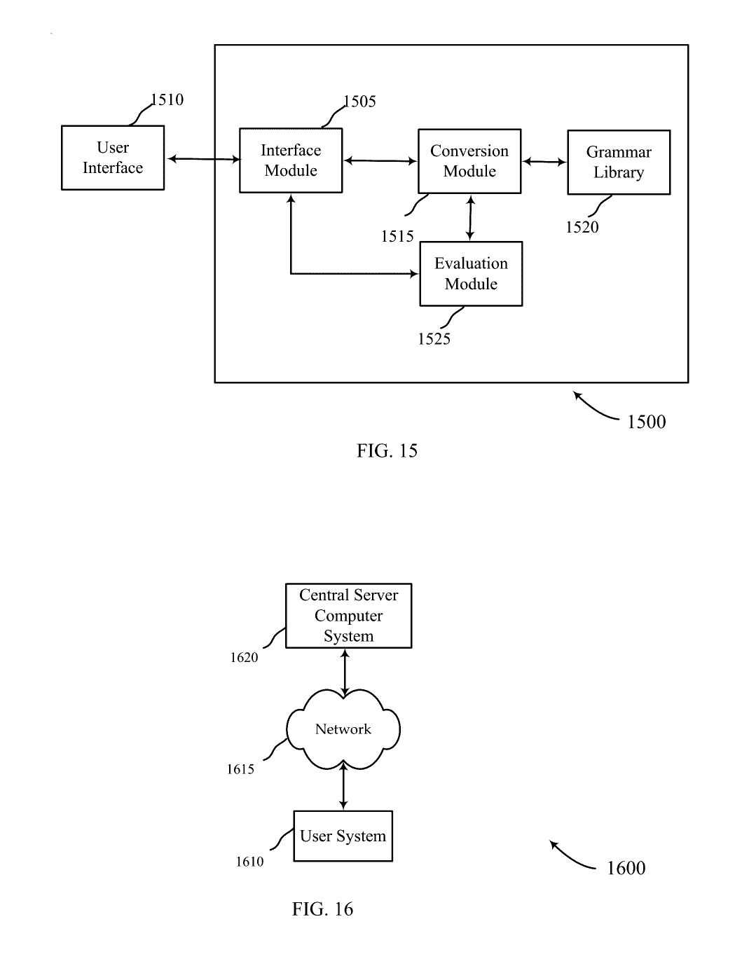

The above examples provide a number of exemplary inputs, outputs, and intermediate steps that may be displayed according to methods and systems of the present disclosure. With reference now to FIG. 15, an exemplary system 1500 of an embodiment is described. The system includes an interface module 1505, that may provide an interface between a user interface 1510 and one or more other modules. The interface module 1505 may include one or more communications interfaces on a computer system, for example, that interact with one or more of a monitor, keyboard, and/or mouse of user interface 1510. A conversion module 1515 is communicatively coupled to the interface module, and functions to convert received input into mathematical expressions and one or more ASTs. In order to perform conversion, the conversion module 1515 accesses a grammar library 1520, and evaluates received input relative to the grammar library to perform conversion functions. An evaluation module 1525 evaluates the ASTs according to functions determined by the conversion module, and outputs results to the interface module 1505. As mentioned above, the evaluation may be performed in intermediate steps, with the results of one or more intermediate steps output as well. In other embodiments, various functions of the interface module 1505, conversion module 1515, grammar library 1520, and evaluation module 1525 may be performed on a local system, or on a remote system connected to a local system through a network. Such a system 1600 is illustrated in FIG. 16. In the embodiment of FIG. 16, a user system 1610 is connected through a network 1615 to a central server computer system 1620, that may perform some or all of the functions described above. The network 1615 may a local or wide area network, such as the Internet. The user system 1610 may include any of a number of user devices, such as a personal computer, tablet computer, handheld device, or other mobile device as are well known. FIGS. 11 and 12 illustrate screen shots of exemplary outputs that may be provided to a user of such systems.

The detailed description set forth above in connection with the appended drawings describes exemplary implementations and does not represent the only examples that may be implemented or that are within the scope of the claims. The term “exemplary” used throughout this description means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts as described.

The various illustrative blocks and modules described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and blue-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not to be limited to the examples and designs described herein but is to be accorded the widest scope consistent with the principles and novel features disclosed herein.

1. A method for receiving and evaluating mathematical statements, comprising:
receiving, at an interface module in a computer system, one or more first order logic (FOL) mathematical statements including hybrid statements mixing mathematical expressions and natural language;
converting, via at least one call to a grammar library stored in a memory of the computer system, portions of the one or more FOL mathematical statements into a plurality of mathematical expressions and one or more abstract syntax tree (AST) connecting the expressions, wherein the grammar library comprises a plurality of FOL objects, FOL predicates and FOL constructors that enable such converting;
evaluating the mathematical expressions and performing operations on the expressions in accordance with the AST; and
performing at least one of storing a result of the transformation in the memory or transmitting a result of the evaluation to the interface module.

2. The method of claim 1, wherein the one or more FOL statements comprise ASCII character representations of a plurality of FOL expressions linked together through ASCII character representations of one or more operators.

3. The method of claim 1, wherein the FOL functions represent one or more objects within a domain.

4. The method of claim 3, wherein the FOL predicates describe a relation among objects within the domain.

5. The method of claim 4, wherein the FOL constructors are used to generate one or more FOL construct based on the one or more FOL predicates and FOL functions.

6. The method of claim 3, wherein the objects are uniquely determined by one or more other objects within the domain.

7. The method of claim 5, wherein FOL constructs are introduced into a hierarchy of terminals and non-terminal symbols as if they were user-defined mathematical functions.
